(19) United States
(12) Patent Application Publication
(10) Pub. No.: US 2017/0218692 A1
(43) Pub. Date: Aug. 3, 2017

(54) "T" Top Step Store Gate

(71) Applicant: Robert Lee Swafford, West Frankfort, IL (US)

(72) Inventor: Robert Lee Swafford, West Frankfort, IL (US)

(21) Appl. No.: 15/011,551

(22) Filed: Jan. 30, 2016

(51) Int. Cl. E06B 9/01; E04H 17/14; E06B 3/50

(52) U.S. Cl. CPC E06B 9/01; E06B 3/50; E04H 17/1426; E06B 2009/002

(57) ABSTRACT

The non-rigid gate device as described may be useful in many application for the general public; gateways in parks, special events, entries to open type office or business building, also large flee-markets often have rigid gates, problems with latches, Other possibilities exist; such as onboard a ship or pleasure boats whereas rigid purpose gates are sometimes left open, this gate is freely placed in a tapered receiver bracket or placed open with the free end resting on a solid surface, rigid gates slam violently in stormy conditions, The non-rigid gate device may be built of metal with a rubber foot to rest on hard surfaces. This gate may be automatically latched when it is placed in a receiver bracket with the auto locking device of this patent application. This invention could be used at airports, parks and welcome centers; or as a garden gate, whereby obstacles often block rigid gates from opening; the inventor foresees many possibilities beyond the stairway use for this non-rigid gate.

### BACKGROUND

Through many years, gate builders designed and built the most rigid gates they could build, often using oblique diagonals to make gates rigid; Searching the market in 2012, no gate was found for use at a stairway. Stairways, in some homes, start at a hallway or room in which there is no place a conventional hinged gate can be left open without the gate interfering with traffic. Some “Snap-in Blocking Devices” are used. This lifetime experienced builder and inventor gave much thought then designed and built the Pivot Post Step Store Gate and followed that a month later with an all purpose Classic Step Store safety Gate. Patent Applications were filed in May and June of 2012. Patent searches have found; no preceding gates built in the described manner of; the Pivot Post Step Store Gate or the Classic Step Store Gate. Research found fabric blocking devices on rods or other apparatus, tied together at four overlapping corners designed to collapse for storage, several collapsible devices were invented for blocking traffic across a room or entry way.

### IN REFERENCE TO DRAWINGS

Perspective drawing FIG. 1: Illustrates a “T-Top’ step store gate in the storage position: In this instance: The non rigid gate is mounted to a stairway wall, at the lower end of an open end stairway, providing passage to an upper level of a family home or dwelling: The gate assembly become a part of a home and is ready to be closed across the stairway to prevent passage of infants or pets. FIG. 1 shows the pivot post1 mounted at the base of an adjacent wall of the stairway, by use of a pivot bracket assembly2 and held vertical by top pivot bracket assembly3. The pivot post1 provides horizontal rotation for a vertical flexing passage blocking assembly.

The Pivot Post1 has a top recessed area9 and a bottom recessed area9; provided for pivotally mounting an assembled vertical flexing gate assembly:

FIG. 2: Is a front elevation of the completed gate assembly: The gate assembly has no more than two horizontal structural beams4 and 6 and they provide mounting surfaces for multiple vertical pickets5 thereby after assembly compose the blocking area for a vertical flexing structure, hereby referred to as a step store gate.

FIG. 2: The gate device is pre-assembled whereby a first bottom one peace structural beam4 will attach to the bottom recessed area9 of the pivot post1 with a pivot pin16; and a second top horizontal beam6 that will attach to the top recessed area9 of the pivot post1 and is thereto mounted with a pivot pin16: The top structural beam6, is hereby strengthened by a top flat surfaced reinforcing beam8 bonded to the top structural beam6 providing additional lateral strength and thereby provides safety with its rounded top edges14 and is also a hand grip device; thereby receiving the name “T”-Top Step Store Gate.

FIG. 6 is a rear elevation view of the “T”-Top step store gate, and may be used as a front mounting surface: The vertical pickets are attached to this rear surface to complete the pivoting assembly: The rounded top ends of the vertical pickets5 attach to the top horizontal beam6, and are skillfully spaced an equal small distance from the “T”-Top beam8, and each vertical picket5 must be equally spaced along the length of the horizontal beams4 and 6 and must be attached precisely vertical with a bottom and a top pivot pin16 in each vertical picket5 inserted through equal spaced pre drilled holes16, passing through washer7 and anchoring into the bottom horizontal beam4 and the top horizontal beam6 Pre-drilled pivot holes16 are provide at the top radius center point of vertical pickets5, followed by equal measure to the center of the bottom horizontal beam4, whereas this measure is transferred to the vertical pickets5 measure, from the top drilled center pivot16, whereby The bottom pivot pin location is established and pre-drilled at all pivot locations16 and they must be precise and equal.

FIG. 6: A plurality of thin nylon or plastic washers7 must be used, one used at each pivot point 16; also a plurality of quality self locking screws16 must be on hand as each contact point is a pivot point16 and each require a washer7 and pivot device16 Details at this point are self evident, insert each pivot pin16 through the vertical picket5 and use washers7 between all pivot surfaces and attach the vertical pickets5 to the horizontal beams6 and attach vertical pickets to horizontal beams4 as described using a washer7 between all pivot surfaces, attach all vertical pickets to beam6 and beam4 as described above; the blocking area of the gate will be assembled, then back to FIG. 2

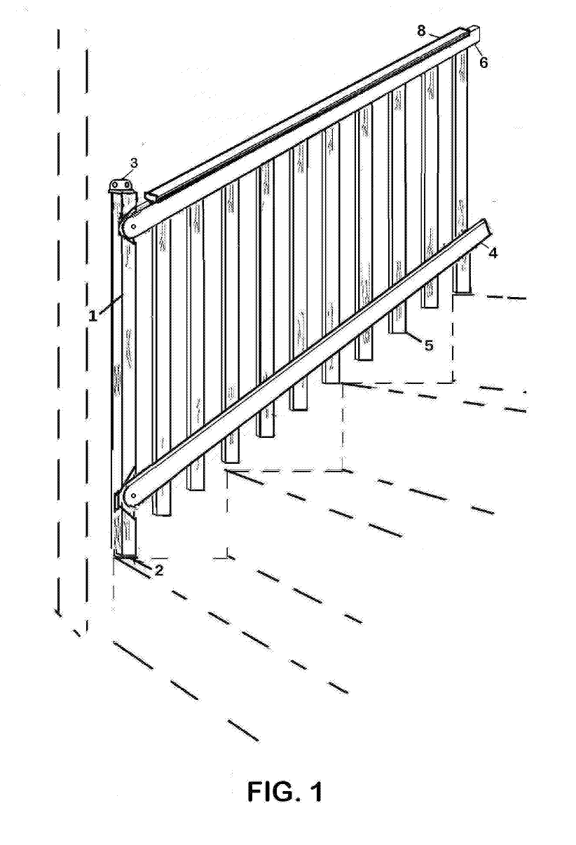

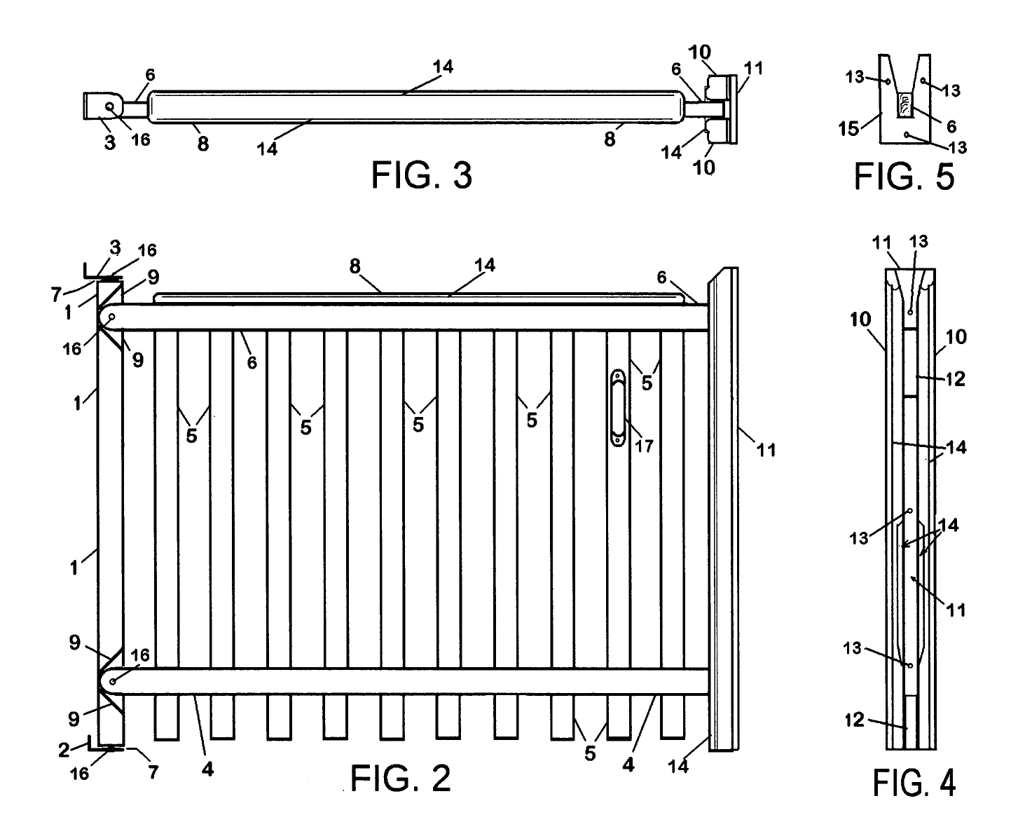

FIG. 2: The first bottom horizontal beam4 mounts to the lower recessed area9 of pivot post1 by inserting a self locking screw through pivot location16 in horizontal beam4 and passing through a washer7, and anchoring onto the pivot post1; the top horizontal beam6 mounts to the top recessed area9 of pivot post1, by use of a self locking screw passing through a pre drilled hole16 and washer7 and anchoring into the pivot post1 and the gate is assembled.

FIG. 3 Illustrates a plan view of the “T” Top reinforcing beam8 concealing most of the top structural beam6 whereas reinforcing beam8 is bonded to structural beam 6 composing a strong structural member “T” Top Beam6

FIG. 3 also shows the top view of the gate receiver assembly with vertical members10 and rear surface material11 visible and architectural rounded shaped surfaces 14

FIG. 4 front elevation view of an architectural designed gate receiver assembly10 that may attach to an existing vertical handrail spindle assembly surface by applying Velcro pads to existing handrails and the rear surface of the vertical receiver assembly10 to hold the assembly vertical in place, and adding binding straps around the unit around each horizontal beam rest12.

FIG. 5 is a ‘Y” tapered gate receiver bracket15 designed for use mounting to a door frame or other firm surface. Pre drilled holes13 are provided for mounting the device with standard woodscrews. The end of beam6 is a cross view.

FIG. 4: Illustrates an elevation view of a gate receiver assembly10, displaying two crafted vertical receivers10 assembled in position with an equal length mounting base11 attached from the rear mounting surface of the mounting base11 holding the vertical receivers10 in a precise equal spaced manner, using the slightly thicker bottom gate beam rest12 to allow freely insertion of the first bottom horizontal gate beams4; and place a second upper slightly thicker spacer12 near the top tapered end of vertical receivers10 properly located as a top beam6 gate rest; whereas the top horizontal beam6 fits between the first gate receiver10 and the second receiver10 without resistance. The FIG. 4 receiver assembly10 will mount to a vertical post or stairway handrail device or mounts to a vertical surface as option to using two FIG. 5 gate receiver brackets15. The vertical receiver assembly10 provides a “Y” tapered receiver for the top beam6 as bottom beam4 enters a rounded lower receiver area of vertical beams10

FIG. 2: The vertical beam10 is top trimmed at an angle, for an appearance option only, of the vertical receiver assembly. The auto latch assembly could not be used with the top trim option.

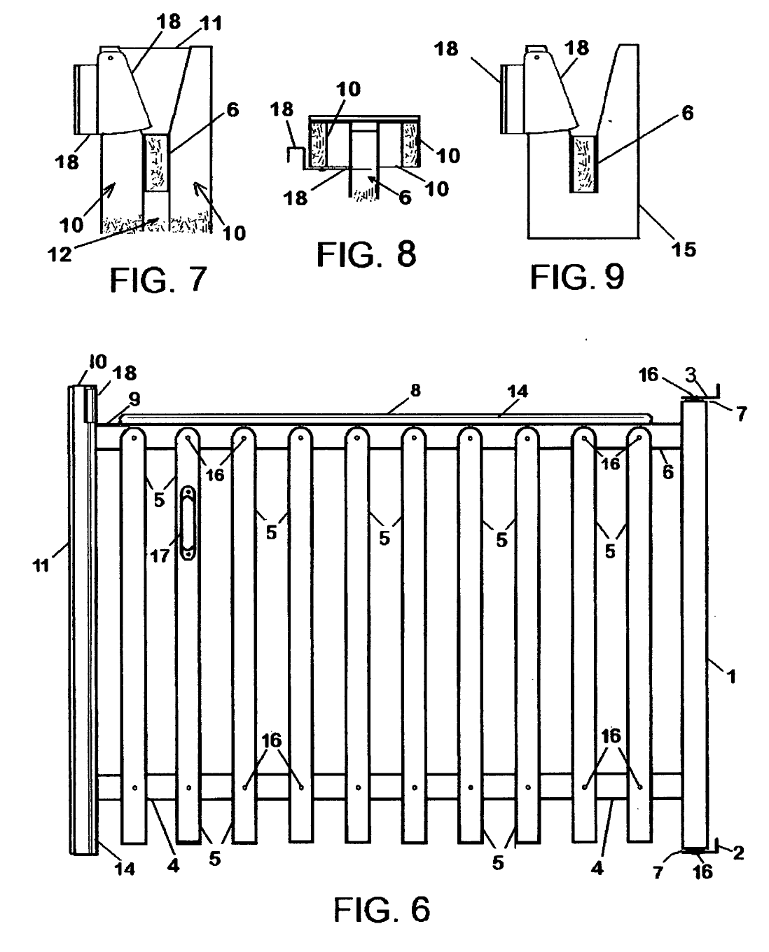

FIG. 6: Shows the vertical receiver assembly10 with a square top and the automatic latching device18 installed. A finger tip pull releases the auto lock18 from the horizontal gate beam6 to allow lifting the gate out of the gate receiver assembly10

FIG. 7: is a sectional drawing of the top portion of the vertical receiver assembly10 whereby the designed auto lock18 restrains lifting the horizontal beam6 from the gate receiver10: Inserting a fingertip at the left of the latching device18, thereby moving and holding it to the left, holds the balanced latch device18 open, and allows the horizontal beam6 to be lifted and the gate opened.

The latching device18 is bell shaped and the pull lever on the left, counter balances the latching device18 whereby it automatically blocks release of the beam6; whereas placing the gate beam6 in the “Y” tapered notch10, depresses the latch assembly18, as it enters the receiver assembly10, and the latch18 falls back to latched position18 after the horizontal beam6 drops to the closed position. The latch device18 may be lowered to near the horizontal beam6 as assembled to be more efficient, the drawing shows how it works.

FIG. 8: Plan view of the latching device18 indicates a flat piece of metal18 projecting over the horizontal beam6 and the finger tip release of the latching device18 on the left. Removing the counter balanced latch18 from the “Y” tapered vertical beams10 and attaching a section of Velcro fabric (not shown) to the mounting surface of the tapered beam10 and replacing the latch device with the correct screw tension, would result in a finger operated latching device.18

FIG. 9: A “Y” tapered receiver bracket15 with a cross section of horizontal beam6 in a receiver bracket15 and a counter balanced latching device,18 is the most proficient method of installing a step store gate, providing two stairway walls exist.

Two tapered receiver brackets15 two are required as mounting a step store gate in a wood framed passageway. Only one latching device,18 would be used.

### BRIEF DESCRIPTION OF THE DRAWINGS

FIG. 1: Perspective view of the invention in the storage position.

FIG. 2: Front elevation of a closed gate with horizontal beams in receiver assembly.

FIG. 3: A plan view of the invention in closed position with the “T” Top rounded surface beam predominant, with the lifting beam end placed in a receiver assembly.

FIG. 4: An architectural designed vertical mounting gate receiver assembly.

FIG. 5: A “Y” tapered receiver bracket of invention, mounts to a doorframe or wall.

FIG. 6: Rear elevation of the invention, in the true spirit of a family safety gate; with a “T”-Top rounded surface beam predominant

FIG. 7: An automatic safety latch locks a horizontal beam in the receiver assembly.

FIG. 8: Plan section view of top horizontal beam latched in a gate receiver assembly.

FIG. 9: A “Y” tapered receiver bracket with an auto latch obstructs opening the gate.

### REFERENCE NUMBERS

1 Vertical pivot post 2 Bottom pivot bracket assembly 3 Top pivot bracket assembly 4 Bottom horizontal beam 5 Vertical pickets 6 Top horizontal beam 7 Thin washers 8 Top handhold safety beam 9 Recessed areas in pivot post, for mounting horizontal beams 10 Two rounded vertical, architectural designed, gate receiver members forming a gate receiver assembly. 11 Rear surface material for vertical gate receiver bracket assembly 12 Bottom and top horizontal beam supports 3 Locations of pre-drilled mounting holes for gate receiver bracket, or mounting gate receiver assembly 14 Rounded edges 15 “Y” tapered gate receiver bracket 16 Pivot pins or pivot pin locations 17 Optional gate lift handle 18 Automatic latching device counter weight balanced.

### BRIEF SUMMARY OF THE INVENTION:

A non-rigid gate will mount to a stairway wall or vertical surface at the top or bottom of a stairway to prevent passage of babies, small children or household pets. This gate flexes and rotates up or down a stairway, and stores along the adjacent stairway wall. The free end of this gate lifts lightly with one hand to close it across the stairway to the opposite wall and is thereby secured in a “Y” tapered gate receiver brackets, thereby blocking access and providing safety for small children. A guardian may lift the operating end of the gate from the receiver bracket and open the gate by rotating it toward or away from the steps, thus providing passage to the stairway. This gate is designed to be the ultimate baby safety gate and household safety gate, protecting children and adults with a widened “T” shaped reinforced top beam having rounded edges. A new auto latching device prevents opening the gate by unknowing persons, is optional.

1; A non-rigid blocking apparatus referred to as a step store gate is assembled with pivot pins and spacer washers at lifting and rotating contact points, and may be installed at the bottom or the top of a stairway or passageway, and will close across the stairway, to provide blockage and thereby provide safety for small children, by preventing access to the stairway; whereas a vertical mounted pivot post provides two recessed mounting areas, for pivotal mounting of the horizontal beams; whereas a series of pivotal mounted vertical pickets are evenly spaced one to the other along the length of the horizontal beams and thereby compose the blocking surface of said gate; whereas lifting the swinging end of the device to the adjacent wall places the gate in the step store position, thereby the gate pivots to the incline of the stairway angle, and the parallel beams remain parallel one to the other and vertical pickets always remain vertical; further, rotating the gate to the closed position across the stairway the horizontal beams are secured in level position in “Y” tapered receiver brackets held in place by the force of gravity; furthermore a balance operated latching device is provided to latch the end of the “T” Top horizontal beam in the receiver bracket, a fingertip action by a person releases the latch device and allows lifting and rotating the horizontal beam to pass through the gateway; thereafter rotating the gate back to the closed horizontal position by lowering the gate beams into the tapered receiver brackets whereby it is automatically latched; whereby the “T” Top beam provides strength and safety, and also provides a firm gripping surface as lifting and rotating the gate, whereas the step store gate is always ready for use as it is needed; furthermore an optional architectural designed vertically mounted gate receiver assembly may be used if needed.

2; the non-rigid blocking apparatus of claim 1;
And the vertical pivot post described herein and described in the specifications and alternate ways a pivot post and pivot brackets may be modified to satisfy the need of a non rigid gate for use of the general public or there pets.

3; the non-rigid blocking apparatus of claim 1;
And the lever mounted bottom and top structural beams whereby providing the mounting areas for multiple vertical pivot mounting blocking devices; and the modifications this designer and inventor envisions in modified applications of general public use.

4; the non-rigid blocking apparatus of claim 1;
And the series of vertical pickets spaced equally one from the other along the length of the two horizontal beams, and as described in the specifications and illustrated in drawings provided; whereby blocking devices are attached with pivot screws each passing through a vertical blocking members and a thin washers to provide firmness as anchoring each pivot pins into the horizontal beams of the blocking structure and thereby preventing scaring and sounds as lifting and rotating the blocking device; and the inventor envisions modified applications of general public use.

5; the non-rigid blocking apparatus of claim 1;
And the “T” Top beam, designed to provide additional latitude strength and safety provided, as rounded top edges are designed to help prevent serious injury if a person of the general public, would fall toward the blocking device; and in addition the “T” Top beam provides a hand grip.

6; the non-rigid blocking apparatus of claim 1;
And the “Y” tapered gate receiver brackets providing a non mechanical device that guides the horizontal beam into the receiver notch, thereafter gravity holds the beam firmly in place; two receiver brackets are required.

7; the non-rigid blocking apparatus of claim 1;
And an automatic receiver latch, is gravity operated and design balanced; the horizontal beam latch will prevent lifting the horizontal beam; whereby a one finger pull will allow the beam to be lifted from the receiver bracket; furthermore the latch mounts on the top receiver bracket only, and the latch may be converted to hand operation by installing a common spring loaded bullet latch, by pressing the small device into a pre-drilled hole that is hidden under the latch device.

8; the non-rigid blocking apparatus of claim 1;
And a vertical mounted gate receiver assembly providing a single device to receive the lifting end of the bottom and the top horizontal beam, whereby providing a top “Y” tapered notch, with a lesser bottom rounded notch for the bottom beam to inter; whereas the device uses a rear surface mounting device secured to all assembly parts to hold the two vertical receiver beams and two beam rest as one unit, composing the vertical mounted gate beam receiver assembly as a single unit, thereby, Velcro and straps may be used to attach the receiver assembly to a stairway handrail assembly; and the horizontal beams of the gate are held in place in the closed position, by the natural force of gravity.
